(19) United States
(12) Patent Application Publication
(10) Pub. No.: US 2024/0162613 A1
(43) Pub. Date: May 16, 2024

(54) ANTENNAS AND COMMUNICATION DEVICE

(71) Applicant: Chengdu Tianma Micro-Electronics Co.,Ltd., Chengdu (CN)

(72) Inventors: Puxiang TANG, Chengdu (CN); Dengming LEI, Chengdu (CN); Zhenyu JIA, Chengdu (CN); Kerui XI, Chengdu (CN); Baiquan LIN, Chengdu (CN); Zuocai YANG, Chengdu (CN); Qinyi DUAN, Chengdu (CN); Yifan BAO, Chengdu (CN)

(21) Appl. No.: 18/123,518

(22) Filed: Mar. 20, 2023

(30) Foreign Application Priority Data
Nov. 11, 2022 (CN) 202211412993.4

(51) Int. Cl. H01Q 9/04; H01Q 3/36

(52) U.S. Cl. CPC H01Q 9/0407; H01Q 3/36

(57) ABSTRACT

Antenna and communication device are provided. The antenna includes a first substrate, a second substrate that are oppositely arranged and a dielectric function layer arranged between the first substrate and the second substrate; a ground layer, arranged on a side of the dielectric functional layer away from the first substrate; a radiation layer, arranged on a side of the dielectric functional layer away from the second substrate, and including a plurality of radiation units, a radiation unit of the plurality of radiation units including a radiation patch and a phase shifter surrounding the radiation patch, and the radiation patch being insulated from the phase shifter; and a wiring layer, arranged on a side of the dielectric functional layer away from the second substrate, including a plurality of first signal lines, and different phase shifters being electrically connected to different first signal lines.

### CROSS-REFERENCE TO RELATED APPLICATION

This application claims priority of Chinese Patent Application No. 202211412993.4, filed on Nov. 11, 2022, the entire contents of which are hereby incorporated by reference.

### FIELD OF THE DISCLOSURE

The present disclosure generally relates to the field of communication technology and, more particularly, relates to an antennas, and a communication device.

### BACKGROUND

Liquid crystal antenna is a new type of arrayed antenna based on a liquid crystal phase shifter. Liquid crystal antennas have broad application prospects in satellite receiving antennas, vehicle radars, 5G base station antennas and the like.

A phase shifter is an important device in the field of microwave radio frequency and is a core component of a phased array antenna. An adjustable phase shifter based on liquid crystal material is a new solution proposed in recent years. Liquid crystal material is a material whose dielectric constant can be controlled by a bias electric or magnetic field. As a bias voltage changes, a dielectric constant of the liquid crystal material also changes continuously, realizing a continuous phase regulation.

In a liquid crystal antenna of a related art, a film layer structure is complicated, which increases a design difficulty.

### BRIEF SUMMARY OF THE DISCLOSURE

One aspect of the present disclosure provides an antenna. The antenna includes a first substrate, a second substrate that are oppositely arranged and a dielectric function layer arranged between the first substrate and the second substrate; a ground layer, arranged on a side of the dielectric functional layer away from the first substrate; a radiation layer, arranged on a side of the dielectric functional layer away from the second substrate, and including a plurality of radiation units, a radiation unit of the plurality of radiation units including a radiation patch and a phase shifter surrounding the radiation patch, and the radiation patch being insulated from the phase shifter; and a wiring layer, arranged on a side of the dielectric functional layer away from the second substrate, including a plurality of first signal lines, different phase shifters being electrically connected to different first signal lines, and the plurality of first signal lines being configured to provide bias voltages to the phase shifters to adjust a dielectric constant of the dielectric functional layer.

Another aspect of the present disclosure provides a communication device. The communication device includes a feed source and an antenna. The antenna includes a first substrate, a second substrate that are oppositely arranged and a dielectric function layer arranged between the first substrate and the second substrate; a ground layer, arranged on a side of the dielectric functional layer away from the first substrate; a radiation layer, arranged on a side of the dielectric functional layer away from the second substrate, and including a plurality of radiation units, a radiation unit of the plurality of radiation units including a radiation patch and a phase shifter surrounding the radiation patch, and the radiation patch being insulated from the phase shifter; and a wiring layer, arranged on a side of the dielectric functional layer away from the second substrate, including a plurality of first signal lines, different phase shifters being electrically connected to different first signal lines, and the plurality of first signal lines being configured to provide bias voltages to the phase shifters to adjust a dielectric constant of the dielectric functional layer. The feed source is on a side of the first substrate away from the second substrate.

Other aspects of the present disclosure can be understood by a person skilled in the art in light of the description, the claims, and the drawings of the present disclosure.

### BRIEF DESCRIPTION OF THE DRAWINGS

Accompanying drawings, which are incorporated in and constitute part of the present specification, illustrate embodiments of the present disclosure and together with a description, serve to explain principles of the present disclosure.

FIG. 1 illustrates a schematic diagram of an antenna;

FIG. 2 illustrates a planar view of an antenna provided by an embodiment of the present disclosure;

FIG. 3 illustrates an A-A cross-sectional view of the antenna in FIG. 2;

FIG. 4 illustrates a planar view of a radiation unit in an antenna provided by an embodiment of the present disclosure;

FIG. 5 illustrates a simulation diagram corresponding to the radiation unit in FIG. 4;

FIG. 6 illustrates a planar view of a radiation unit after a phase shifter is cut off consistent with various embodiments of the present disclosure;

FIG. 7 illustrates a simulation diagram corresponding to the radiation unit in FIG. 6;

FIG. 8 illustrates another A-A cross-sectional view of the antenna in FIG. 2;

FIG. 9 illustrates another A-A cross-sectional view of the antenna in FIG. 2;

FIG. 10 illustrates another A-A cross-sectional view of the antenna in FIG. 2;

FIG. 11 illustrates another planar view of an antenna provided by an embodiment of the present disclosure;

FIG. 12 illustrates another planar view of an antenna provided by an embodiment of the present disclosure;

FIG. 13 illustrates a planar view of a radiation unit in an antenna provided by an embodiment of the present disclosure;

FIG. 14 illustrates another planar view of an antenna provided by an embodiment of the present disclosure;

FIG. 15 illustrates another planar view of an antenna provided by an embodiment of the present disclosure;

FIG. 16 illustrates a B-B cross-sectional view of the antenna in FIG. 14;

FIG. 17 illustrates another B-B cross-sectional view of the antenna in FIG. 14;

FIG. 18 illustrates another planar view of a radiation unit in an antenna provided by an embodiment of the present disclosure;

FIG. 19 illustrates another planar view of a radiation unit in an antenna provided by an embodiment of the present disclosure;

FIG. 20 illustrates another planar view of a radiation unit in an antenna provided by an embodiment of the present disclosure; and

FIG. 21 illustrates a schematic diagram of a communication device provided by an embodiment of the present disclosure.

### DETAILED DESCRIPTION

Various exemplary embodiments of the present disclosure will be described in detail with reference to the accompanying drawings. It should be noted that, unless specifically stated otherwise, a relative arrangement of components and steps, numerical expressions and numerical values set forth in the embodiments do not limit the scope of the present disclosure.

The following description of at least one exemplary embodiment is merely illustrative and is not intended to limit the present disclosure and specification or use thereof.

Techniques, methods, and apparatus known to a person skilled in the art may not be discussed in detail, but where appropriate, such techniques, methods, and apparatus should be considered as part of the present specification.

In all examples shown and discussed herein, any specific value should be construed as illustrative only and is not used as a limitation. Accordingly, other examples of exemplary embodiments may have different values.

It is apparent to a person skilled in the art that various modifications and variations can be made in the present disclosure without departing from the spirit or scope of the disclosures. Accordingly, the present disclosure is intended to cover modifications and variations of the present disclosure that fall within the scope of corresponding claims (claimed technical solutions) and equivalents thereof. It should be noted that, implementations provided in the embodiments of the present disclosure may be combined with each other without conflict.

It should be noted that similar numerals and letters refer to similar items in the accompanying drawing described below. Therefore, once an item is defined in one accompanying drawing, further discussion of the item in subsequent accompanying drawings may not be required.

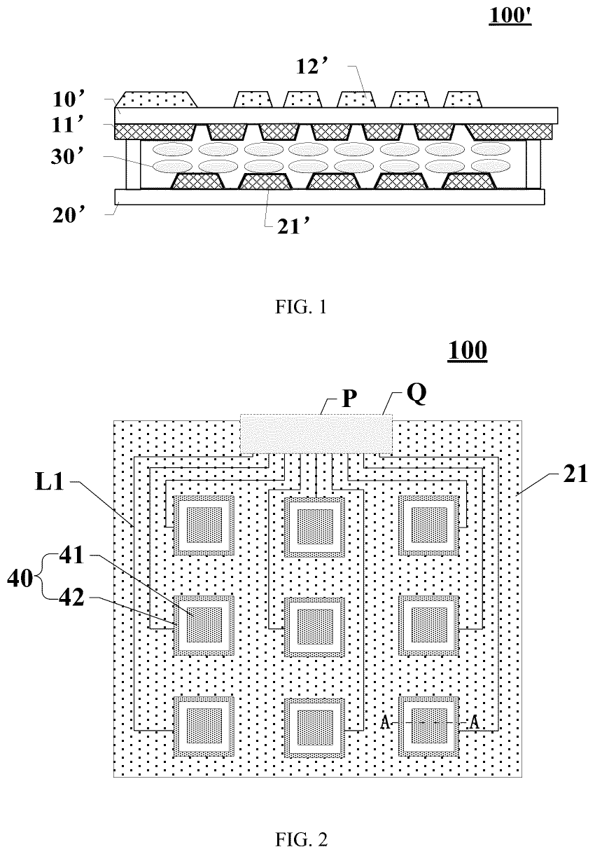

FIG. 1 illustrates a schematic diagram of an antenna 100′ provided in a related art. The antenna 100′ includes a first substrate 10′ and a second substrate 20′ that are oppositely arranged and liquid crystals 30′ filled between the first substrate 10′ and the second substrate 20′. Radiation unit layers 12′ are arranged on a side of the first substrate 10′ away from the liquid crystals 30′, ground layers 11′ are arranged on a side of the first substrate 10′ facing the liquid crystals 30′, and phase shifters 21′ are arranged on a side of the second substrate 20′ facing the liquid crystals 30′. The above structure of the antenna is complicated, and the radiation unit layers 12′ and the ground layers 11′ need to be respectively arranged on two sides of the first substrate 10′, and the phase shifters 21′ needs to be arranged on a side of the second substrate 20′, which increases a design difficulty.

In view of the above, the present disclosure provides an antenna, including a first substrate, a second substrate, and a dielectric functional layer arranged between the first substrate and the second substrate; a ground layer arranged on a side of the dielectric functional layer away from the first substrate; a radiation layer arranged on a side of the dielectric functional layer away from the second substrate, and including a plurality of radiation units, a radiation unit of the plurality of radiation units includes a radiation patch and a phase shifter, the phase shifter being arranged around the radiation patch, and the radiation patch being insulated from the phase shifter; and a wiring layer, arranged on a side of the dielectric functional layer away from the second substrate, and including a plurality of first signal lines, different phase shifters being electrically connected to different first signal lines, and the plurality of first signal lines are configured to provide bias voltages to the phase shifters and adjust a dielectric constant of the dielectric functional layer. The radiation patches for radiating an electromagnetic wave and the phase shifters for shifting a phase are arranged on a same layer, and the phase shifters surround the radiation patches. Therefore, a film layer structure of the antenna is simplified, which is conducive to simplifying an antenna design.

The above is a core idea of the present disclosure, and technical solutions in the embodiments of the present disclosure will be clearly and completely described below in conjunction with the accompanying drawings in the embodiments of the present disclosure. Based on the embodiments of the present disclosure, all other embodiments obtained by a person skilled in the art without making creative efforts belong to the protection scope of the embodiments of the present disclosure.

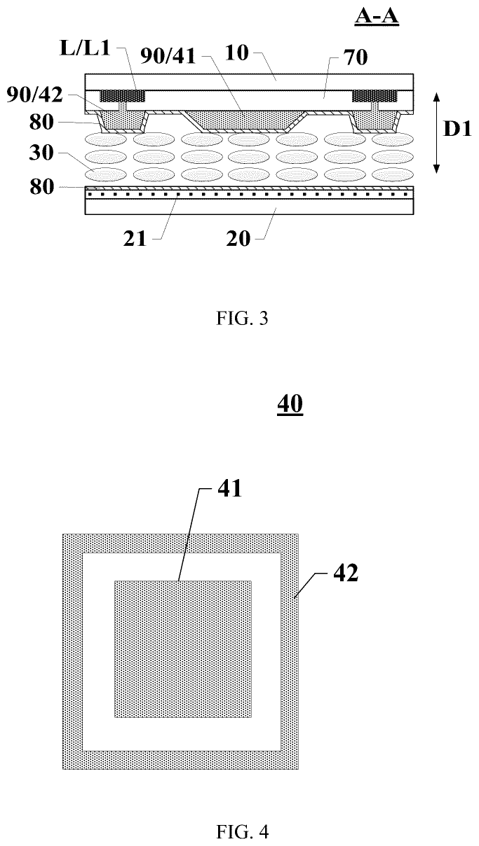

FIG. 2 illustrates a planar view of an antenna provided by an embodiment of the present disclosure. FIG. 3 illustrates an A-A cross-sectional view of the antenna in FIG. 2. Referring to FIG. 2 and FIG. 3, in one embodiment, an antenna 100 includes: a first substrate 10 and a second substrate 20 that are oppositely arranged and a dielectric function layer 30 arranged between the first substrate 10 and the second substrate 20; a ground layer 21 arranged on a side of a dielectric functional layer 30 away from the first substrate 10; a radiation layer 90 arranged on a side of the dielectric functional layer 30 away from the second substrate 20, the radiation layer including a plurality of radiation units 40, a radiation unit 40 including a radiation patch 41 and a phase shifter 42 surrounding the radiation patch 41, and the radiation patch 41 being insulated from the phase shifter 42; and a wiring layer L arranged on the side of the dielectric functional layer 30 away from the second substrate 20, and including a plurality of first signal lines L1, different phase shifters 42 being electrically connected to different first signal lines L1, and the plurality of first signal lines L1 being configured to provide bias voltages to the phase shifters 42 to adjust a dielectric constant of the dielectric functional layer 30.

It should be noted that, FIG. 2 and FIG. 3 only illustrate a relative positional relationship of the ground layer 21, the radiation layer 90 and the wiring layer L in the antenna. Number of radiation units 40 included on the radiation layer is not limited, nor are sizes of the radiation patch 41 and the phase shifter 42 in the radiation unit 40 limited. FIG. 3 only schematically shows a film layer structure of the antenna and does not represent an actual number and a size of the film layers.

Optionally, in one embodiment, in the antenna, the radiation layer 90 and the wiring layer L are arranged on the first substrate 10 side, the ground layer 21 is arranged on the second substrate 20 side. A specific layer relationship between the radiation layer 90 and the wiring layer L on the side of the first substrate 10 are described in subsequent embodiments.

Optionally, in one embodiment, the radiation patch 41 and the phase shifter 42 may be made of a metal material, such as copper. Optionally, in one embodiment, the first signal lines L1 on the wiring layer may be made of a transparent conductive material, such as indium tin oxide.

In the antenna 100, the dielectric functional layer 30 is arranged between the first substrate 10 and the second substrate 20 that are oppositely arranged, and the radiation layer 90 and the wiring layer L are arranged on the side of the dielectric functional layer 30 away from the second substrate 20, and the ground layer 21 is arranged on a first side of the functional layer 30 away from the first substrate 10. The radiation layer 90 includes a plurality of radiation units 40, and each radiation unit 40 respectively includes a radiation patch 41 and a phase shifter 42 arranged around the radiation patch 41. The radiation patch 41 is insulated from the phase shifter 42, and different phase shifters 42 are respectively electrically connected to different first signal lines L1 on the wiring layer L. A bias voltage is obtained through the first signal line L1, so that a voltage difference is formed between the phase shifter 42 and the ground layer 21, and the dielectric constant of the dielectric function layer 30 is adjusted.

Optionally, in the antenna, the dielectric functional layer 30 arranged between the first substrate 10 and the second substrate 20 may be a liquid crystal layer. Optionally, alignment layers 80 are arranged on upper and lower sides of the liquid crystal layer. In some other embodiments, the dielectric functional layer 30 can also be realized by another metamaterial dielectric layer with a variable dielectric constant except a liquid crystal layer. In a forming process of the antenna, after a film layer on the first substrate 10 side and a film layer on the second substrate 20 side are formed respectively, the two film layers are oppositely arranged to form a box.

Optionally, the antenna is a reflector antenna. When an electromagnetic wave signal emitted by an external feed source is directed to the reflector antenna 100, the radiation patch 41 in the antenna 100 acts as a secondary radiation source. After the radiation patch 41 receives the electromagnetic wave, the electromagnetic wave oscillates in a space formed by the radiation patch 41, the phase shifter 42, the dielectric functional layer 30 and the ground layer 21 and radiates the electromagnetic wave in a direction opposite to an incident direction. When a bias voltage is supplied to the phase shifter 42 through the first signal line L1, an electric field is generated between the phase shifter 42 and the ground layer 21 to drive liquid crystal molecules in the liquid crystal layer to deflect and change the dielectric constant of the liquid crystal layer. Therefore, a coupling effect between the radiation patch 41 and the phase shifter 42 is changed, so that an initial phase of an electromagnetic signal transmitted on the radiation patch 41 is changed. A phase shift function and a beam control of the electromagnetic signal are realized according to a relationship between a beam pointing and an excitation phase. In the present disclosure, the radiation patch 41 for radiating an electromagnetic wave and the phase shifter 42 for shifting a phase are arranged on a same layer. The phase shifter 42 surrounds the radiation patch 41, and the phase shifter 42 obtains a bias voltage through the first signal line L1. Compared with a complex structure of the antenna in a related art, in the embodiment, integrating the radiating patch 41 and the phase shifter 42 in the radiation layer can realize a phase shifting function without introducing a complicated feeding network layer into the antenna, thereby facilitating an antenna design.

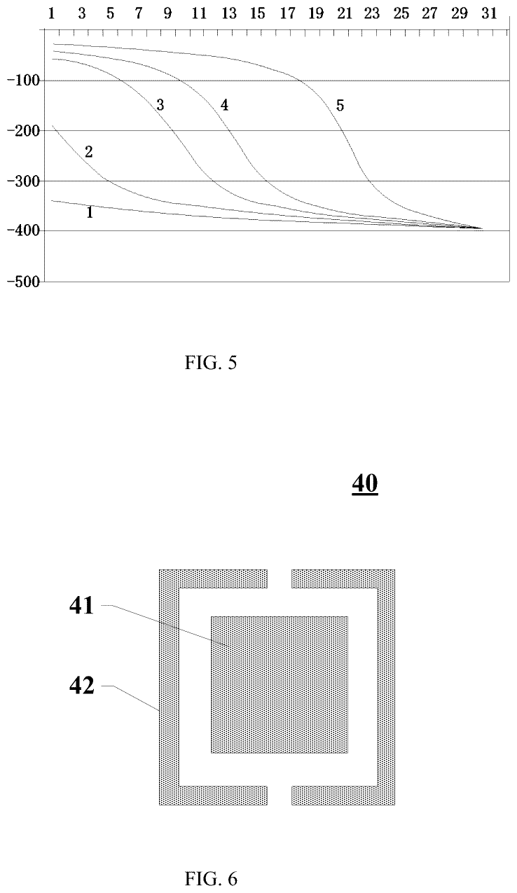

FIG. 4 illustrates a planar view of the radiation unit 40 in an antenna provided by an embodiment of the present disclosure. FIG. 5 illustrates a simulation diagram corresponding to the radiation unit 40 in FIG. 4. In an optional embodiment, the phase shifter 42 is a continuous ring structure. FIG. 6 illustrates a planar view of the radiation unit 40 after the phase shifter 42 is cut off consistent with various embodiments of the present disclosure. FIG. 7 illustrates a simulation diagram corresponding to the radiation unit 40 in FIG. 6. In the simulation diagrams corresponding to FIG. 5 and FIG. 7, an abscissa represents a frequency, an ordinate represents a phase, and different curves (specially curves 1-5) respectively represent different bias voltages provided to a phase shifter. When a dielectric constant of a dielectric functional layer changes, a reflection phase changes with different dielectric constants to generate a phase change curve (phase-frequency curve), i.e., different curves correspond to different dielectric constants.

In the embodiment, when a bias voltage is provided to the phase shifter 42, the dielectric constant of the dielectric functional layer 30 changes, and a coupling capacitance between the phase shifter 42 and the radiation patch 41 inside the phase shifter 42 changes, so that a phase of an electromagnetic wave signal transmitted on the radiation patch 41 changes, realizing a phase shifting function. It should be noted that an electromagnetic wave signal received by the radiation patch 41 is an electromagnetic wave signal emitted by an external feed source. Referring to FIG. 6, assuming that a bias voltage corresponding to curve 1 is V1, a bias voltage corresponding to curve 2 is V2, a bias voltage corresponding to curve 3 is V3, a bias voltage corresponding to curve 4 is V4, bias voltage corresponding to curve 5 is V5, and V5>V4>V3>V2>V1, when the phase shifter 42 is a continuous ring structure, at a same frequency, as dielectric constants corresponding to the five curves change, a reflection phase also changes accordingly, so that a phase adjustment of a reflected electromagnetic wave can be realized. After the phase shifter 42 is cut off, referring to FIG. 6 and FIG. 7, even though different curves correspond to different bias voltages, the dielectric constant changes, but the reflection phase hardly changes. That is, if the phase shifter 42 is cut off, the antenna does no longer have a phase modulation function, a degree of phase shift in a working frequency band of the antenna is obviously reduced, and a phase adjustment function of the radiation unit 40 basically disappears. Therefore, in one embodiment, the phase shifter 42 is arranged as a continuous ring structure, which can effectively adjust a phase of the reflected electromagnetic wave and satisfy a phase shifting function of the antenna within a normal bandwidth range.

Referring to FIG. 3, in one optional embodiment, the radiation layer 90 and the wiring layer L are on a side of the first substrate 10 facing the dielectric functional layer 30. Along a first direction D1, the radiation layer 90 is isolated from the wiring layer L1 by an insulating layer 70, and the phase shifter 42 is electrically connected to the first signal line L1 through the via hole penetrating through the insulating layer 70. The first direction D1 is a dielectric The thickness direction of the functional layer 30.

Specifically, the embodiment shown in FIG. 3 shows a solution in which the radiation layer 90 and the wiring layer L are arranged in a box. In an actual forming process, after the wiring layer L and the radiation layer 90 are formed on the first substrate 10, when the first substrate 10 and the second substrate 20 are oppositely arranged to form an antenna structure, the first substrate 10 can protect the wiring layer L and the radiation layer 90. If the wiring layer L and the radiation layer 90 are arranged outside the box, the wiring layer L and the radiation layer 90 may be corroded to affect a performance of the antenna. If a protective layer is added to avoid corrosion, an overall thickness of the antenna increases and a cost increases. Therefore, in the embodiment, the wiring layer L and the radiation layer 90 are arranged in the box, which is conductive to preventing the radiation layer 90 and the wiring layer L from being corroded. No other film structure needs to be introduced into the antenna structure, which is conductive to simplifying an overall structure of the antenna and reducing a cost.

Referring to FIG. 3, when the radiation layer 90 and the wiring layer L are arranged in the box, the radiation layer 90 and the wiring layer L are arranged on different layers. The radiation layer 90 is isolated from the wiring layer L by the insulating layer 70, and the phase shifter 42 in the radiation layer 90 is electrically connected to the first signal line L1 on the wiring layer through a via hole penetrating through an insulating layer.

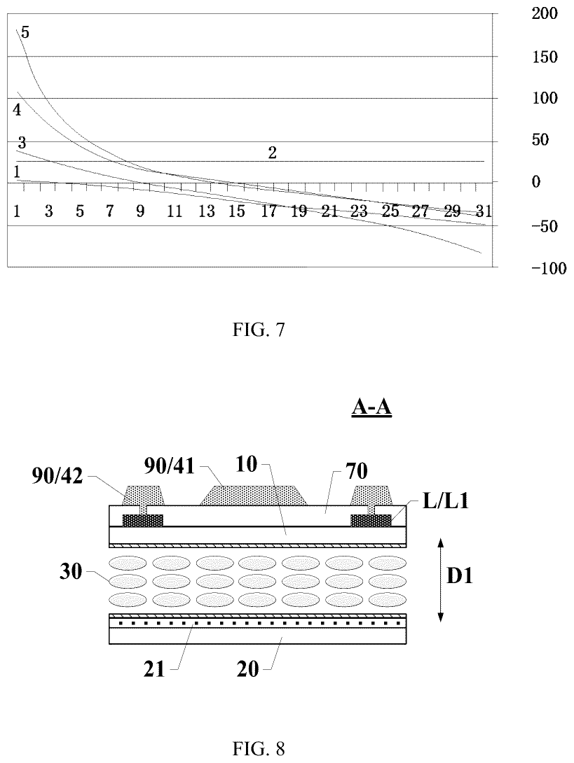

FIG. 8 illustrates another A-A cross-sectional view of the antenna in FIG. 2. One embodiment shows a solution of arranging the radiation layer 90 and the wiring layer L outside the box.

Referring to FIG. 8, in one optional embodiment, the radiation layer 90 and the wiring layer L are on a side of the first substrate 10 away from the dielectric functional layer 30. Along the first direction D1, the radiation layer 90 is isolated from the wiring layer L by the insulating layer 70, and the phase shifter 42 is electrically connected to the first signal line L1 through a via hole penetrating through the insulating layer 70. The first direction D1 is a thickness direction of the dielectric functional layer 30.

Specifically, the radiation layer 90 and the wiring layer L are arranged on the side of the first substrate 10 away from the dielectric functional layer 30, that is, the radiation layer 90 and the wiring layer L are arranged outside the box, which is conductive to precisely controlling a thickness of the dielectric functional layer 30. The dielectric function layer 30 is a liquid crystal layer, which is conductive to accurately controlling a thickness of the liquid crystal cell. Since a thickness uniformity of the dielectric functional layer 30 has a direct impact on a flatness of a phase-shift characteristic curve of the radiation unit 40 in the antenna, arranging the radiation layer 90 and the wiring layer L are arranged outside the box helps to improv a box thickness uniformity of the dielectric functional layer 30, thereby helping to improve a flatness of a phase-shift characteristic curve of the radiation unit 40 in the antenna, and a precise phase-shift function of the antenna. Considering that a high-frequency antenna has high requirements on a design accuracy of the antenna structure, a solution of arranging the radiation layer 90 and the wiring layer L outside the box is more conducive to meeting design requirements of the high-frequency antenna. Since a design accuracy of a low-frequency antenna is lower than a design accuracy of the high-frequency antenna, a structure in which the wiring layer L and the radiation layer 90 are arranged in the box has little influence on low frequencies, so the structure in which the wiring layer L and the radiation layer 90 are arranged in the box is especially suitable for a low frequency antenna.

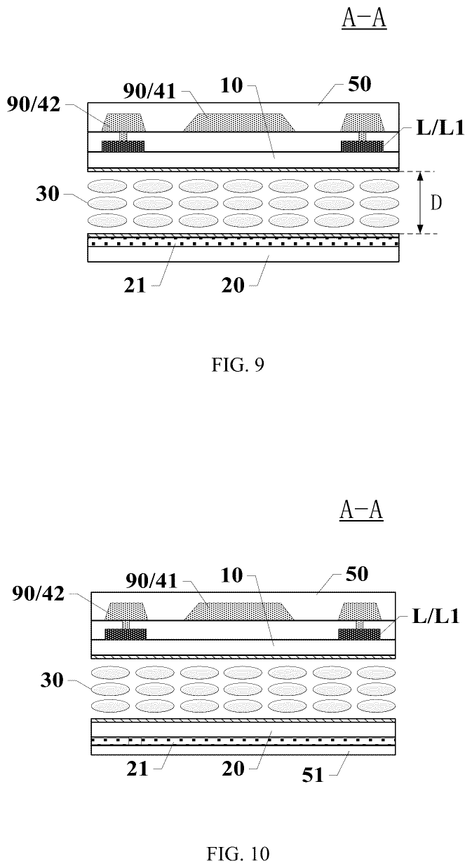

FIG. 9 illustrates another A-A cross-sectional view of the antenna in FIG. 2. One embodiment shows another solution of arranging the radiation layer 90 and the wiring layer L outside the box.

Referring to FIG. 9, in one optional embodiment, the antenna also includes an insulating protection layer 50 on a side of the radiation layer 90 and the wiring layer L away from the first substrate 10. An orthographic projection of the insulating protection layer 50 to the first substrate 10 covers the radiation layer 90 and the wiring layer L.

Specifically, when the radiation layer 90 and the wiring layer L are arranged outside the box, the embodiment introduces the insulating protection layer 50 on the side of the radiation layer 90 and the wiring layer L away from the first substrate 10. The insulating protection layer 50 covers the side of the radiation layer 90 and the wiring layer L away from the first substrate 10, the insulating protection layer 50 can isolate the radiation layer 90 and the wiring layer L from an external environment and prevents the radiation layer 90 and the wiring layer L from being corroded, which is conductive to ensuring a reliability of an antenna performance. Optionally, the insulating protection layer 50 includes an inorganic material such as silicon nitride.

Referring to FIG. 8 and FIG. 9, in one optional embodiment, the radiation layer 90 is on a side of the wiring layer L away from the first substrate 10.

Optionally, when the radiation layer 90 and the wiring layer L are arranged outside the box, the radiation layer 90 can be arranged on the side of the wiring layer L away from the first substrate 10, i.e., the radiation layer 90 is arranged outside the wiring layer L, which is conductive to reducing a distance between the radiation layer 90 and the electromagnetic wave L, thereby improving a radiation performance of the radiation patch 41 on the radiation layer 90 to an electromagnetic wave.

FIG. 10 illustrates another A-A cross-sectional view of the antenna in FIG. 2. One embodiment shows another solution of arranging the radiation layer 90 and the wiring layer L outside the box. A difference between the embodiment shown in FIG. 10 and the embodiment shown in FIG. 9 lies in a location of the ground layer 21. The embodiment shown in FIG. 9 shows a solution of arranging the ground layer 21 on a side of the second substrate 20 facing the dielectric function layer 30. The embodiment shown in FIG. 10 shows a solution of arranging the ground layer 21 on a side of the second substrate 20 away from the dielectric functional layer 30.

When the ground layer 21 is arranged on a surface of the second substrate 20 facing the dielectric function layer 30 or away from the dielectric function layer 30, the ground layer 21 can form an electric field with the phase shifters 42 to drive a liquid crystal to deflect to change a dielectric constant of the liquid crystal. When the ground layer 21 is arranged outside the box (i.e., on the side of the second substrate 20 away from the dielectric functional layer 30), to prevent the ground layer 21 from being corroded by an external environment, a protective layer 51 covering the ground layer 21 may be introduced on a side of the ground layer 21 away from the second substrate 20. When the ground layer 21 is arranged in a box (i.e., on a side of the second substrate 20 facing the dielectric functional layer 30), no protective layer needs to be introduced to the antenna to protect the ground layer 21, and the second substrate 20 can isolate the ground layer 21 from outside and protect the ground layer 21, which is conductive to simplifying the antenna structure.

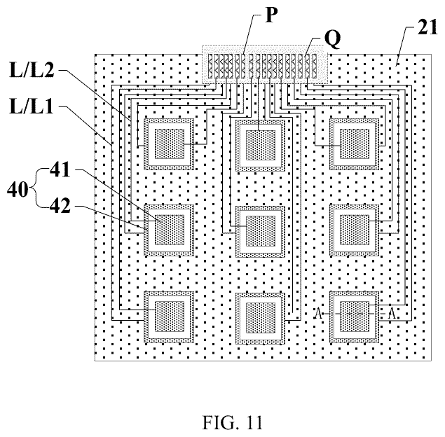

The embodiments shown in FIGS. 2-3 and FIGS. 8-9 show solutions in which the phase shifter 42 is connected to the first signal line L1 on the wiring layer L in the radiation unit 40 included in the antenna, and a bias voltage is obtained through the first signal line L1. In some other embodiments, referring to FIG. 11, in the radiation unit 40 included in the antenna, the radiation patch 41 is also electrically connected to the second signal line L2 on the wiring layer L. FIG. 11 illustrates another planar view of an antenna provided by an embodiment of the present disclosure. In one optional embodiment, the wiring layer L further includes second signal lines L2, and different radiation patches 41 are respectively electrically connected to different second signal lines L2.

The embodiment shows a solution in which the phase shifter 42 and the radiation patch 41 in the radiation unit 40 are respectively connected to the first signal line L1 and the second signal line L2 on the wiring layer L. A bias voltage can be provided to the phase shifter 42 only through the first signal line L1 and a bias voltage can also be provided to the radiation patch 41 through the second signal line L2 while a bias voltage is provided to the phase shifter 42 through the first signal line L1. When a bias voltage is provided to the phase shifter 42 through the first signal line L1, and a bias voltage is provided to the radiation patch 41 through the second signal line L2, both the phase shifter 42 and the radiation patch 41 can form electric fields with the ground layer 21 to change the dielectric constant of the dielectric functional layer 30 so that the antenna can work at a second fixed frequency. When the antenna is actually used, according to requirements of a working frequency, only the first signal line L1 can be controlled to transmit a bias voltage so that a first fixed frequency is used as a working frequency of the antenna, or the first signal line L1 and the second signal line L2 can be controlled to transmit bias voltages at a same time so that a second fixed frequency is used as the working frequency of the antenna, realizing a dual-frequency multiplexing function of the antenna. Moreover, only the second signal line L2 needs to be added without introducing other complicated structures, so the dual-frequency multiplexing function can be realized without increasing a structural complexity of the antenna.

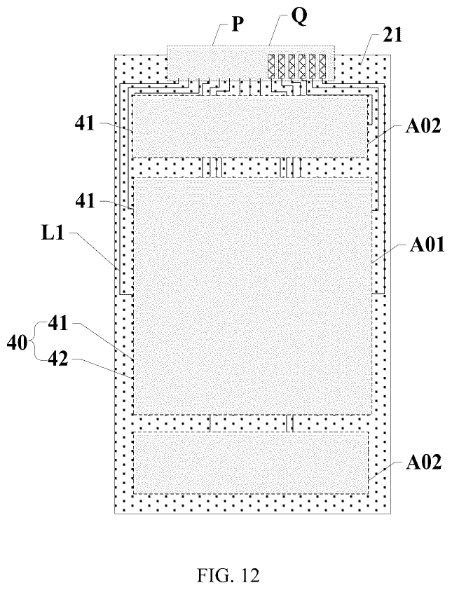

FIG. 12 illustrates another planar view of an antenna provided by an embodiment of the present disclosure. One embodiment shows a solution of differentially designing areas of the radiation patches 41 of part of radiation units 40 in a same antenna.

Referring to FIG. 12, in one optional embodiment, the radiation layer includes a first sub-radiation area A01 and second sub-radiation areas A02, and each of the first sub-radiation area A01 and the second sub-radiation areas A02 includes a plurality of radiation units 40. An area of the radiation patch 41 in the radiation unit 40 in the first sub-radiation area A01 is S1, an area of the radiation patch 41 in the radiation unit 40 in the second sub-radiation area A02 is S2, and S1<S2.

The radiation patch 41 radiates through an edge thereof after receiving an electromagnetic wave. The larger the area of the radiation patch 41 is, the wider a phase modulation range is. In in the antenna provided by the embodiment, the radiation layer includes the first sub-radiation area A01 and the second sub-radiation areas A02. The area of the radiation patch 41 in the first sub-radiation area A01 is smaller than the area of the radiation patch 41 in the second sub-radiation areas A02. A phase modulation range of the second sub-radiation area A02 is wider than a phase modulation range of the first sub-radiation area A01. In an actual application process, the second sub-radiation areas A02 can correspond to areas of the antenna that requires a relatively large phase modulation, and the first sub-radiation area A01 can correspond to the area of the antenna that requires a relatively small phase modulation, which is especially suitable for a relatively large antenna area. The areas of the radiation patches 41 are designed differently in areas with different phase modulation requirements, to meet phase modulation requirements of the antenna in different areas.

It should be noted that the embodiment shown in FIG. 12 only shows a solution in which the second sub-radiation areas A02 are on upper and lower sides of the first sub-radiation area A01 and does not limit the actual positional relationship between the second sub-radiation areas A02 and the first sub-radiation area A01. In an actual application process, the areas of the first sub-radiation area A01 and the second sub-radiation areas A02 in the antenna can be adjusted according to actual needs, which are not specifically limited herein.

It should be noted that, FIG. 12 only illustrates a solution of differentially designing the areas of the radiation patches 41 in the first sub-radiation area A01 and the second sub-radiation area A02 when only the phase shifter 42 in the radiation unit 40 is connected to the first signal line L1. When the phase shifter 42 in the radiation unit 40 is connected to the first signal line L1 and the radiation patch 41 is connected to the second signal line L2, the first sub-radiation area A01 and the second sub-radiation area A02 can also be introduced into the antenna and the areas of the radiation patches 41 in the first sub-radiation area A01 and the second sub-radiation area A02 are designed differently, so that a dual-frequency multiplexing is realized, and requirements of the phase modulation range can be met in different areas of the antenna.

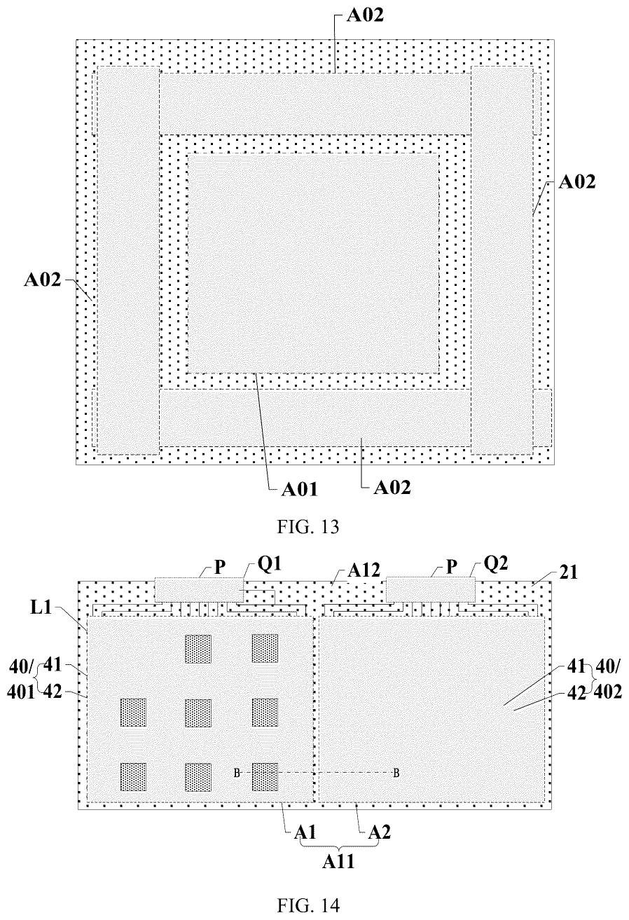

FIG. 13 illustrates a planar view of a radiation unit in an antenna provided by an embodiment of the present disclosure. One embodiment shows another solution of differentially designing the areas of the radiation patches 41 of part of radiation units 40 in a same antenna. referring to FIG. 13, in one optional embodiment, the second sub-radiation areas A02 are arranged around the first sub-radiation area A01.

Specifically, the embodiment in FIG. 13 shows a solution in which the second sub-radiation areas A02 are arranged around the first sub-radiation area A01. When the radiation units are uniformly arranged on the antenna in an array, optionally, a central phase corresponding to the radiation units at a center of the array is controlled to be zero, a phase of the radiation unit increases monotonically from the center to an edge. Therefore, for different areas of the antenna, areas requiring a larger phase modulation range are likely to appear in an edge area of the antenna, and areas requiring a smaller phase modulation range may appear in a middle area of the antenna. In the embodiment, since the area of the radiation patch 41 in the second sub-radiation area A02 is larger than the area of the radiation patch 41 in the first sub-radiation area A01, the second sub-radiation areas A02 are arranged around the first sub-radiation area A0, that is, the second sub-radiation areas A02 correspond to edge areas of the antenna, which can meet requirements of the edge areas of the antenna for a larger phase modulation range. A differential design of the area of the radiation patch 41 in the edge area and the central area of the antenna satisfies phase modulation range requirements of different areas, making an overall phase modulation of the antenna easier to realize.

Referring to FIG. 12, in one optional embodiment, the antenna includes a binding area Q including a plurality of conductive pads P. The phase shifters 42 in the first sub-radiation area A01 and the second sub-radiation area A02 are respectively connected to the conductive pads P of a same binding area Q through different first signal lines L1.

Specifically, the embodiment shows a solution in which the binding area Q is introduced into the antenna, and the first signal lines L1 are electrically connected to the conductive pads P in the binding area Q. Optionally, the binding area Q is configured to bind a control chip. In practical application, a bias voltage signal provided by the control chip to the conductive pad P can be transmitted to the phase shifter 42 connected to the first signal lines L1 through the first signal lines L1. When the first sub-radiation area A01 and the second sub-radiation areas A02 are introduced into the antenna, the first signal lines L1 connected to the phase shifters 42 in the first sub-radiation area A01 and the second sub-radiation areas A02 can be connected to the conductive pads P in a same binding area Q. Therefore, a same control chip can be used to control the supply of bias signals to the first sub-radiation area A01 and the second sub-radiation area A02, thereby simplifying an overall structure of the antenna.

It should be noted that, referring to FIG. 11 and FIG. 12, when the phase shifter 42 in the radiation unit 40 is connected to the first signal line L1 and the radiation patch 41 in the radiation unit 40 is connected to the second signal line L2, the first signal line L1 and the second signal line L2 corresponding to the radiation unit 40 in the first sub-radiation area A01 and the second sub-radiation area A02 can be connected to different conductive pads P in a same binding area Q, different binding areas Q and control chips don't need to be introduced for the first signal line L1 and the second signal line L2 respectively, which is conductive to simplifying an overall structure of the antenna.

FIG. 14 illustrates another planar view of an antenna provided by an embodiment of the present disclosure. One embodiment shows a solution in which the antenna includes a first radiation area A1 and a second radiation area A2.

Referring to FIG. 14, in one optional embodiment, the antenna includes at least one first radiation area A1, at least one second radiation area A2, the first binding area Q1 corresponding to the first radiation area A1 and the second binding area Q2 corresponding to the second radiation area A2, the first binding area Q1 and the second binding area Q2 respectively include a plurality of conductive pads P.

The first radiation area A1 is arranged with first radiation units 401 in an array, the second radiation area A2 is arranged with second radiation units 402 in an array, and areas of the radiation patches 41 in the first radiation unit 401 and the second radiation unit 402 are different. The phase shifter 42 in the first radiation unit 401 is electrically connected to the conductive pad P in the first bonding area Q1 through the first signal line L1, and the phase shifter 42 in the second radiation unit 402 is electrically connected to the conductive pad P in the second bonding area Q2 through the first signal line L1.

Specifically, in the embodiment, the antenna including a first radiation area A1 and a second radiation area A2 is taken as an example for illustration and does not limit number of the first radiation area A1 and the second radiation area A2 included in the antenna. In some other embodiments, the antenna may further include two or more first radiation areas A1 or may further include two or more second radiation areas A2.

In the embodiment, the first radiation units 401 are arranged in an array in the first radiation area A1, and the second radiation units 402 are arranged in an array in the second radiation area A2. In the embodiment, number of radiation units 40 in the first radiation area A1 and number of radiation units 40 in the second radiation area A2 being same is taken as an example for illustration, which is not limited herein. In some other embodiments, number of radiation units 40 in the first radiation area A1 and number of radiation units 40 in the second radiation area A2 may also be different. The area of the radiation patch 41 in the first radiation area A1 is different from the area of the radiation patch 41 in the second radiation area A2. The radiation patch 41 radiates through an edge thereof after receiving an electromagnetic wave. The larger the area of the radiation patch 41 is, the wider a phase modulation range is. Optionally, a bias voltage obtained by the phase shifter 42 in the radiation unit 40 through the first signal line L1 is determined according to a working frequency. After a frequency is selected, optionally, the bias voltage of the phase shifter 42 of the radiation unit 40 does not change any more. In the embodiment, by differentially designing the areas of the radiation patches 41 in the first radiation area A1 and the second radiation area A2, and differentially designing bias voltages provided to the phase shifters 42 in the first radiation area A1 and the second radiation area A2, the first radiation area A1 and the second radiation area A2 of the antenna can respectively correspond to different working frequencies.

Optionally, a working frequency corresponding to the first radiation area A1 is a low frequency, and a working frequency corresponding to the second radiation area A2 is a high frequency, so that the antenna can be applied to two working scenarios. When the first radiation units 401 in the first radiation area A1 are selected to work, the second radiation units 402 in the second radiation area A2 do not work, and the antenna is applied to a low frequency area to improve a radiation performance of a low frequency antenna. When the second radiation units 402 in the second radiation area A2 are selected to work, the first radiation units 401 in the first radiation area A1 do not work, the antenna is applied to a high-frequency area to improve a radiation performance of a high-frequency antenna. In some other embodiments, the working frequency corresponding to the first radiation area A1 can also be a high frequency, and the working frequency corresponding to the second radiation area A2 can also be a low frequency, which is not limited herein.

In the first radiation unit 401 of the first radiation area A1, the phase shifter 42 is electrically connected to the conductive pad P in the first binding area Q1. In the second radiation unit 402 of the second radiation area A2, the phase shifter 42 is electrically connected to the conductive pad P in the second binding area Q2. Optionally, the first binding area Q1 and the second binding area Q2 can be bound to different control chips respectively, so that an application frequency of the antenna can be switched through different control chips to realize a dual-frequency multiplexing function of the antenna.

It should be noted that number of radiation units 40 shown in the first radiation area A1 and the second radiation area A2 in FIG. 14 is only for illustration and does not limit an actual number of radiation units 40 in the first radiating area A1 and the second radiating area A2.

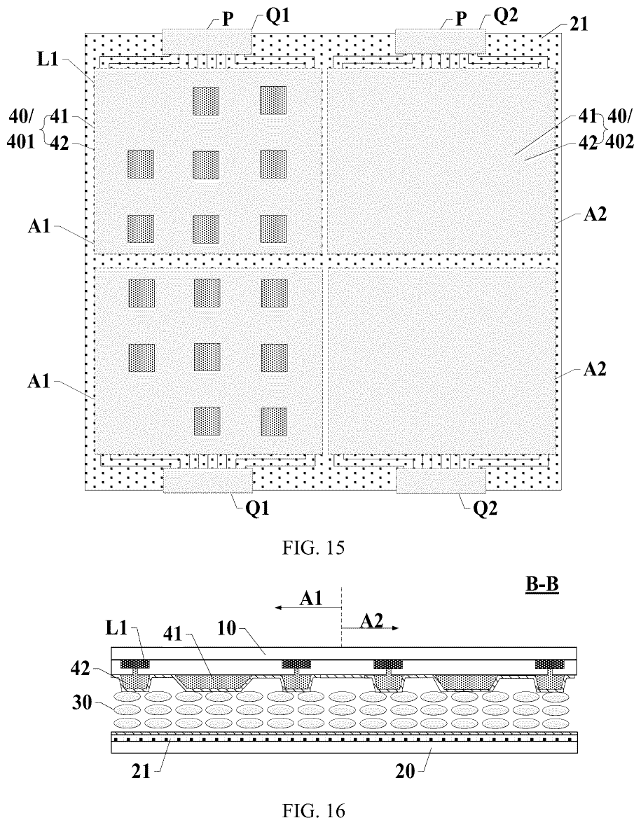

FIG. 15 illustrates another planar view of an antenna provided by an embodiment of the present disclosure. One embodiment shows a solution in which the antenna includes two first radiation areas A1 and two second radiation areas A2. Optionally, the two first radiation areas A1 may respectively correspond to different first binding areas Q1, and along an arrangement direction of the two first radiation areas A1, two first binding areas Q1 are respectively on two sides of the first radiation area A1. The two second radiation areas A2 may respectively correspond to different second binding areas Q2, and along an arrangement direction of the two second radiation areas A2, two second binding areas Q2 are respectively on two sides of the second radiation area A2. Optionally, the two first radiation areas A1 correspond to a same working frequency, and the two second radiation areas A2 correspond to another working frequency, to increase a radiation area of the antenna at different working frequencies.

FIG. 16 illustrates a B-B cross-sectional view of the antenna in FIG. 14. In one optional embodiment, the first radiation areas A1 and the second radiation areas A2 share a same first substrate 10 and a same second substrate 20. Referring to FIG. 14 and FIG. 16, when the antenna includes the first radiation area A1 and the second radiation area A2, the first radiation units 401 in the first radiation area A1 and the second radiation units 402 in the second radiation area A2 are arranged on a same first substrate 10, and the ground layer 21 corresponding to the first radiation units 401 and the second radiation units 402 are also arranged on a same second substrate 20, thereby forming at least two antenna areas suitable for different working frequencies a full-plane antenna. The radiation unit 40 in the first radiation area A1 and the second radiation area A2 can be forming in a same process, which is conductive to reducing an overall forming complexity of the antenna.

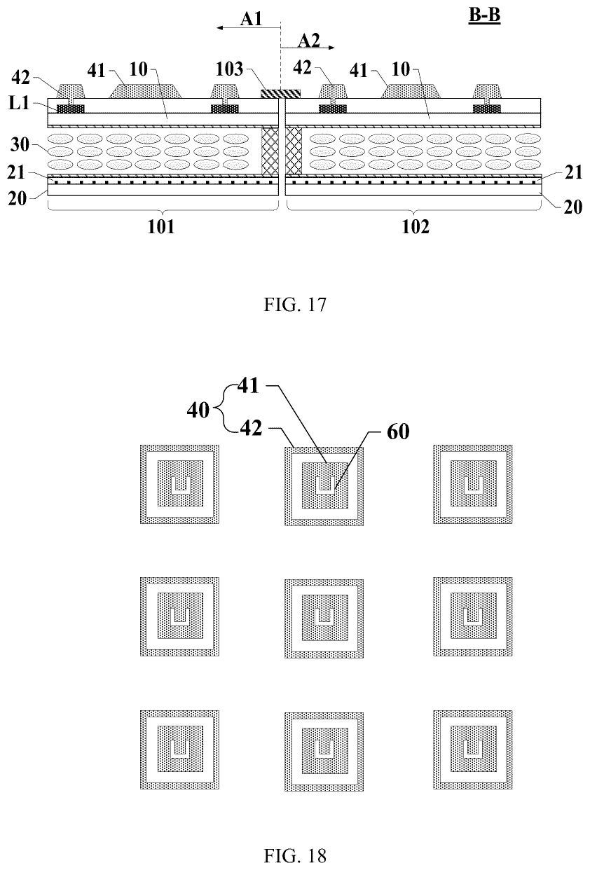

FIG. 17 illustrates another B-B cross-sectional view of the antenna in FIG. 14. In one optional embodiment, the antenna includes a first sub-antenna 101 in the first radiation area A1 and a second sub-antenna 102 in the second radiation area A2. The first substrate 10 of the first sub-antenna 101 is spliced with the first substrate 10 of the second sub-antenna 102, and the second substrate 20 of the first sub-antenna 101 is spliced with the second substrate 20 of the second sub-antenna 102.

Specifically, the embodiment shows a solution of forming a large-area antenna structure by splicing the first sub-antenna 101 and the second sub-antenna 102. Specifically, the first radiation area A1 of the antenna is arranged with the first sub-antenna 101, and the second radiation area A2 is arranged with the second sub-antenna 102. Optionally, a box thicknesses of the first sub-antenna 101 and a box thicknesses of the second sub-antenna 102 are same, the first substrate 10 of the first sub-antenna 101 and the first substrate 10 of the second sub-antenna 102 are coplanar, and the second substrate 20 of the first sub-antenna 101 and the second substrate 20 of the second sub-antenna 102 are coplanar. Optionally, the first sub-antenna 101 and the second sub-antenna 102 are spliced through a connection structure 103, thereby realizing a dual-frequency multiplexing function of the antenna. When the first sub-antenna 101 and the second sub-antenna 102 with smaller areas are used for splicing, the first sub-antenna 101 and the second sub-antenna 102 with smaller areas can be formed first. When a size of the antenna is small, the antenna is more convenient to store and transport, and when the antenna with a larger area needs to be used, the antenna can be spliced according to needs, thereby not only meeting a usage need of the antenna, but also helping to reduce a transportation cost and the like.

When splicing is used to form a large-area antenna structure, each sub-antenna can correspond to different working frequencies or a same working frequency according to actual application needs, which is not specifically limited herein.

Referring to FIG. 14, in one optional embodiment, the radiation layer includes a radiation area A11 and an edge area A12 arranged around the radiation area. The first radiation area A1 and the second radiation area A2 are in the radiation area A11, and the binding area Q is in the edge area A12.

Specifically, for an entire antenna structure, the radiation area A11 includes an area arranged with the radiation units 40. The radiation area A11 is configured to radiate an electromagnetic wave, and an area around the radiation area A11 can be regarded as the edge area A12 of the antenna. When the antenna structure is formed by splicing, arranging the binding area Q in the edge area A12 can prevent the binding area Q from being adjacent to a splicing seam, which is conductive to preventing a radiation performance of the antenna from being affected by arranging the binding area Q between two radiation areas. When different radiation areas on a same antenna share a same first substrate 10 and a same second substrate 20, compared to arranging the binding area Q inside the antenna, arranging the binding area Q in the edge area A12 of the antenna is more conducive to simplifying a forming difficulty of the binding area Q.

Referring to FIG. 9, in one optional embodiment, a thickness of the dielectric functional layer 30 is D, and 4 μm≤D≤10 μm.

The thickness of the dielectric functional layer 30 directly affects a response time of the dielectric functional layer 30. The smaller the thickness of the dielectric functional layer 30, the shorter the response time of the liquid crystal, which can play a role of rapid phase modulation. The greater the thickness of the dielectric functional layer 30, the longer the response time of the liquid crystal, which affects a sensitivity of a phase modulation to a certain extent. When the thickness of the dielectric functional layer 30 is small, such as less than 4 μm, an accuracy of the thickness of the dielectric functional layer 30 is difficult to be guaranteed, when the thickness of the dielectric functional layer 30 is larger, such as greater than 10 μm, the response time is longer, which is not conducive to improving a phase modulation sensitivity. Therefore, in the embodiment, arranging the thickness of the dielectric functional layer 30 to be between 4 μm and 10 μm, can not only ensure a short response time of the dielectric functional layer 30, improve a phase modulation sensitivity of the antenna, but also precisely control the thickness of the dielectric functional layer 30.

Optionally, the thickness of the dielectric functional layer 30 is 5 μm≤D≤8 μm, 6 μm≤D≤9 μm, or the like, which can also be flexibly arranged according to actual needs.

FIG. 18 illustrates another planar view of the radiation unit 40 in an antenna provided by an embodiment of the present disclosure. In one optional embodiment, at least part of the radiation patches 41 are provided with a slit 60 penetrating through the radiation patch 41 along a thickness direction of the radiation patch 41. Specifically, an electromagnetic wave signal emitted by a feed source can be radiated through the radiation patch 41, and an original shape of the radiation patch 41 determines an original resonance point. When the slit 60 is arranged on the radiation patch 41, the slit 60 can increase resonance points of the radiation patch 41. Arranging two or more resonance points adjacently is conductive to improving a working bandwidth of the antenna.

In one optional embodiment, the slit 60 is U-shaped. The U-shaped slit 60 has a simple structure and is easy to be formed. In practical application, a size of the U-shaped slit 60 can be adjusted according to a specific bandwidth and gain requirements.

Referring to FIG. 18, in one optional embodiment, in a same radiation unit 40, a shape of an outer edge of an orthographic projection of the radiation patch 41 on the first substrate 10 is a first shape, and a shape of an inner edge of an orthographic projection of the phase shifter 42 on the first substrate 10 is a second shape. The first shape is same as the second shape.

In the embodiment shown in FIG. 18, in an orthographic projection on the first substrate, an outer contour of the radiation patch 41 is a square, an inner contour of the phase shifter 42 is also a square, i.e., the first shape and the second shape have a same shape, which is conductive to simplifying an overall structure of the radiation unit 40 and reduce a forming difficulty of the antenna. FIG. 18 is only illustrated by taking the first shape and the second shape as a square as an example. In some other embodiments, the first shape and the second shape can also be embodied in other shapes described in subsequent embodiments.

Referring to FIG. 18, in one optional embodiment, an interval between the radiation patch 41 and the phase shifter 42 is equal everywhere in a same radiation unit 40. It should be noted that the equal interval means that a shortest distance from any point on an outer circumference of the radiation patch 41 to the phase shifter 42 is equal. When a distance between the radiation patch 41 and the phase shifter 42 is arranged to be equal everywhere, and an outer contour shape of the radiation patch 41 and an inner contour shape of the phase shifter 42 are arranged to be same, the radiation unit 40 is a symmetrical structure as a whole. The antenna structure pursues a simplest structure to achieve an optimal performance. The radiation units 40 have a symmetrical structure and are evenly distributed in the antenna, which is conducive to improving a uniformity of the antenna pattern and avoiding a pattern distortion due to structural inhomogeneity.

In one optional embodiment, the first shape and the second shape are at least one of square, triangle, and circle.

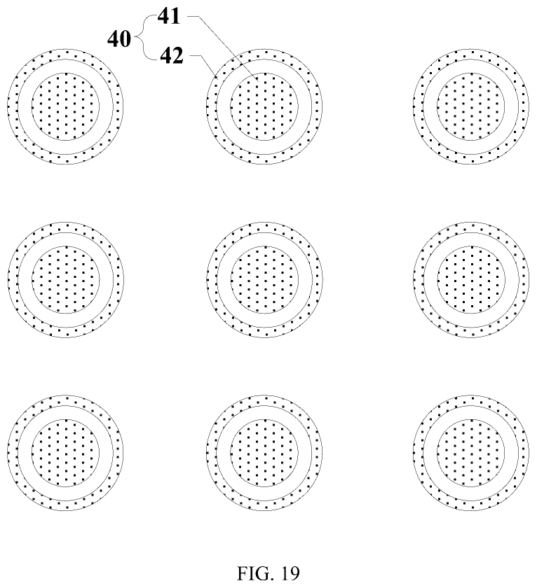

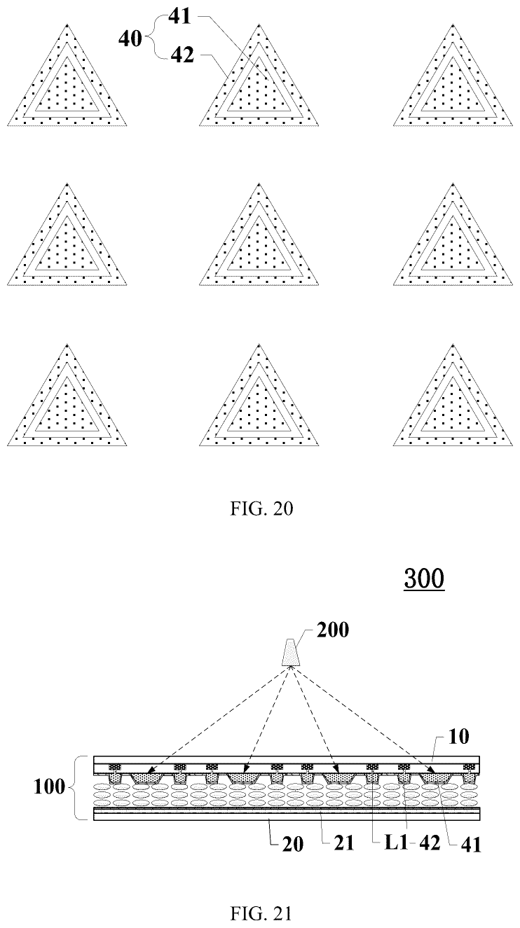

In the above embodiments, an outer contour of the radiation patch 41 in the radiation unit 40 and an inner contour of the phase shifter 42 being both square is taken as an example for illustration. The antenna adopting the radiation unit 40 with the above structure is suitable for traditional vertical polarization scenarios, such as 5G antennas. In some other embodiments, referring to FIG. 19 and FIG. 20, the first shape corresponding to the radiation patch 41 and the second shape corresponding to the phase shifter 42 can also be embodied in other shapes. FIG. 19 illustrates another planar view of a radiation unit in an antenna provided by an embodiment of the present disclosure. FIG. 20 illustrates another planar view of a radiation unit in an antenna provided by an embodiment of the present disclosure. In one embodiment shown in FIG. 19, referring to FIG. 3, in an orthographic projection of the radiation unit 40 on the first substrate 10, an outer contour of the radiation patch 41 and an inner contour of the phase shifter 42 are both triangular. The antenna adopting the radiation unit 40 with the above structure is suitable for special polarization scenarios such as 30-degree polarization or 150-degree polarization scenarios including special conference antennas. In one embodiment shown in FIG. 20, referring to FIG. 3, in an orthographic projection of the radiation unit 40 on the first substrate 10, the outer contour of the radiating patch 41 and the inner contour of the phase shifter 42 are both circular. The antenna adopting the radiation unit 40 with the above structure is suitable for satellite circular polarization scenarios. In practical application, shapes of the radiation patch 41 and the phase shifter 42 in the radiation unit 40 can be adjusted to meet different application needs of the antenna, thereby improving a versatility of the antenna provided by the embodiments of the present disclosure.

FIG. 21 illustrates a schematic diagram of a communication device provided by an embodiment of the present disclosure. Referring to FIG. 21, based on a same inventive concept, the present disclosure also provides a communication device 300, including a feed source 200 and the antenna of any of the above embodiments. The feed source 200 is on a side of the first substrate 10 away from the second substrate 20.

Optionally, in one embodiment, the antenna is a reflector antenna, and the feed source 200 is configured as a primary radiator to convert bound electromagnetic waves into radiated electromagnetic wave energy and irradiates the reflector antenna to form a high-gain reflection surface antenna. Optionally, the feed source 200 is at a focal point of the antenna to ensure a uniform illumination of the antenna by the feed source 200.

Referring to FIG. 21, an electromagnetic wave signal emitted by the feed source 200 is directed to the reflector antenna 100, the radiation patch 41 in the antenna 100 acts as a secondary radiation source. After the radiation patch 41 as the secondary radiation source receives an electromagnetic wave signal, an electromagnetic wave oscillates in a space formed by the radiation patch 41, the phase shifter 42, the dielectric functional layer 30 and the ground layer 21, and the electromagnetic wave is radiated in a direction opposite to the incident direction. When bias voltages are supplied to the phase shifters 42 through the first signal lines L1, an electric field is generated between the phase shifters 42 and the ground layer 21 to drive liquid crystal molecules in a liquid crystal layer to deflect and change the dielectric constant of the liquid crystal layer. Therefore, a coupling effect between the radiation patch 41 and the phase shifter 42 is changed, so that an initial phase of the electromagnetic signal transmitted on the radiation patch 41 is changed, to realize a phase shift and a beam steering of the electromagnetic signal according to a relationship between beam pointing and excitation phase.

In summary, the antenna and the communication device provided by the present disclosure at least achieve the following beneficial effects.

In the antenna provided by the present disclosure, the dielectric functional layer is arranged between the first substrate and the second substrate that are oppositely arranged. The radiation layer and the wiring layer are arranged on the side of the dielectric functional layer away from the second substrate, and the ground layer is arranged on the first side of the dielectric functional layer away from the first substrate. The radiation layer includes a plurality of radiation units, and each radiation unit includes the radiation patch and the phase shifter arranged around the radiation patch, and the radiation patch is insulated from the phase shifter. Different phase shifters are respectively electrically connected to different first signal lines on the wiring layer, and bias voltages are obtained through the first signal lines, so that voltage differences are formed between the phase shifters and the ground layer, thereby realizing an adjustment of the dielectric constant of the dielectric functional layer, and further realizing a phase regulation of the antenna. In the present disclosure, the radiation patch for radiating an electromagnetic wave and the phase shifter for shifting phases are arranged on a same layer, and the phase shifter surrounds the radiation patch, which is conductive to simplifying a film layer structure of the antenna and simplifying an antenna design.

Although some specific embodiments of the present disclosure have been described in detail by way of examples, a person skilled in the art should understand that the above examples are for illustration only and are not intended to limit the scope of the present disclosure. The above embodiments can be modified by a person skilled in the art without departing from the scope and spirit of the present disclosure. The protection scope of the present disclosure is limited by appended claims.

What is claimed is:

1. An antenna, comprising:
a first substrate, a second substrate that are oppositely arranged and a dielectric function layer arranged between the first substrate and the second substrate;
a ground layer, arranged on a side of the dielectric functional layer away from the first substrate;
a radiation layer, arranged on a side of the dielectric functional layer away from the second substrate, and including a plurality of radiation units, a radiation unit of the plurality of radiation units including a radiation patch and a phase shifter surrounding the radiation patch, and the radiation patch being insulated from the phase shifter; and
a wiring layer, arranged on a side of the dielectric functional layer away from the second substrate, including a plurality of first signal lines, different phase shifters being electrically connected to different first signal lines, and the plurality of first signal lines being configured to provide bias voltages to the phase shifters to adjust a dielectric constant of the dielectric functional layer.

2. The antenna according to claim 1, wherein the phase shifter is a continuous ring structure.

3. The antenna according to claim 1, wherein:
the radiation layer and the wiring layer are on a side of the first substrate facing the dielectric functional layer, along a first direction, the radiation layer is isolated from the wiring layer by an insulating layer, and the phase shifter is electrically connected to a first signal line through a via hole penetrating through the insulating layer;
the first direction is a thickness direction of the dielectric functional layer; and
the radiation layer is on a side of the wiring layer away from the first substrate.

4. The antenna according to claim 1, wherein:
the radiation layer and the wiring layer are on a side of the first substrate away from the dielectric functional layer, along a first direction, the radiation layer is isolated from the wiring layer by an insulating layer, and the phase shifter is electrically connected to a first signal line through a via hole penetrating through the insulating layer;
the first direction is a thickness direction of the dielectric functional layer; and
the radiation layer is on a side of the wiring layer away from the first substrate.

5. The antenna according to claim 4, further comprising:
an insulating protection layer, on a side of the radiation layer and the wiring layer away from the first substrate, and an orthographic projection of the insulating protection layer to the first substrate covering the radiation layer and the wiring layer.

6. The antenna according to claim 1, wherein the ground layer is on a side of the second substrate facing the dielectric functional layer.

7. The antenna according to claim 1, wherein the wiring layer further includes second signal lines, and different radiation patches are electrically connected to different second signal lines.

8. The antenna according to claim 1, wherein:
the radiation layer includes a first sub-radiation area and a second sub-radiation area, and each of the first sub-radiation area and the second sub-radiation area includes a plurality of radiation units; and
an area of the radiation patch in the radiation unit of the first sub-radiation area is S1, an area of the radiation patch in the radiation unit of the second sub-radiation area is S2, and S1<S2.

9. The antenna according to claim 8, wherein the second sub-radiation area is arranged on a periphery of the first sub-radiation area.

10. The antenna according to claim 8, comprising binding areas, a binding area of the binding areas comprising a plurality of conductive pads, wherein:
the phase shifter in the first sub-radiation area and the phase shifter in the second sub-radiation area are respectively connected to a conductive pad of a same binding area through different first signal lines.

11. The antenna according to claim 1, comprising at least one first radiation area, at least one second radiation area, a first binding area corresponding to the first radiation area, a second binding area corresponding to the second radiation area, and the first binding area and the second binding area respectively comprising a plurality of conductive pads, wherein:
a first radiation area of the at least one first radiation area is arranged with first radiation units arranged in an array, a second radiation area of the at least one second radiation area is arranged with second radiation units arranged in an array, and the radiation patch in the first radiation unit and the radiation patch in the second radiation unit have different areas; and
the phase shifter in the first radiation unit is electrically connected to the conductive pad in the first binding area through a first signal line, and the phase shifter in the second radiation unit is electrically connected to the conductive pad in the second binding area through a first signal line.

12. The antenna according to claim 11, wherein the first radiation area and the second radiation area share a same first substrate and a same second substrate.

13. The antenna according to claim 11, comprising a first sub-antenna in the first radiation area and a second sub-antenna in the second radiation area, the first substrate of the first sub-antenna being spliced with the first substrate of the second sub-antenna, and the second substrate of the first sub-antenna being spliced with the second substrate of the second sub-antenna.

14. The antenna according to claim 11, wherein the radiation layer includes a radiation area and an edge area arranged around the radiation area, the first radiation area and the second radiation area are in the radiation area, and the binding area is in the edge area.

15. The antenna according to claim 1, wherein at least part of the radiation patches is arranged with slits, and a slit of the slits penetrates through the radiation patch along a thickness direction of the radiation patch.

16. The antenna according to claim 15, wherein the slit is U-shaped.

17. The antenna according to claim 1, wherein:
in a same radiation unit, a shape of an outer edge of an orthographic projection of the radiation patch on the first substrate is a first shape, a shape of an inner edge of an orthographic projection of the phase shifter on the first substrate is a second shape, and the first shape is same as the second shape.

18. The antenna according to claim 17, wherein an interval between the radiation patch and the phase shifter is equal everywhere in a same radiation unit.

19. The antenna according to claim 17, wherein the first shape and the second shape are at least one of square, triangle and circle.

20. A communication device, comprising a feed source and an antenna, wherein the antenna comprises:
a first substrate, a second substrate that are oppositely arranged and a dielectric function layer arranged between the first substrate and the second substrate;
a ground layer, arranged on a side of the dielectric functional layer away from the first substrate;
a radiation layer, arranged on a side of the dielectric functional layer away from the second substrate, and including a plurality of radiation units, a radiation unit of the plurality of radiation units including a radiation patch and a phase shifter surrounding the radiation patch, and the radiation patch being insulated from the phase shifter;
a wiring layer, arranged on a side of the dielectric functional layer away from the second substrate, and including a plurality of first signal lines, different phase shifters being electrically connected to different first signal lines, and the plurality of first signal lines being configured to provide bias voltages to the phase shifters to adjust a dielectric constant of the dielectric functional layer; and
the feed source being on a side of the first substrate away from the second substrate.
